(19) United States
(12) Patent Application Publication
(10) Pub. No.: US 2026/0239199 A1
(43) Pub. Date: Aug. 13, 2026

(54) TRANSMITTING SCHEDULING REQUEST AND BUFFER STATUS REPORT WITH CELL DISCONTINUOUS TRANSMISSION OR RECEPTION

(71) Applicant: Apple Inc., Cupertino, CA (US)

(72) Inventors: Peng CHENG, Beijing (CN); Alexander SIROTKIN, Hod Hasharon (IL); Dan WU, Beijing (CN); Fangli XU, Beijing (CN); Haijing HU, Los Gatos, CA (US); Naveen Kumar R. PALLE VENKATA, San Diego, CA (US); Ping-Heng KUO, London (GB); Ralf ROSSBACH, Munich (DE); Sethuraman GURUMOORTHY, San Ramon, CA (US); Sigen YE, San Diego, CA (US); Yuqin CHEN, Beijing (CN); Zhibin WU, Los Altos, CA (US)

(21) Appl. No.: 19/471,932

(22) PCT Filed: Apr. 4, 2023
(86) PCT No.: PCT/CN2023/086225

§ 371 Date: Oct. 2, 2025

(51) Int. Cl. H04W 52/02; H04W 76/28

(52) U.S. Cl. CPC H04W 52/0216; H04W 76/28

(57) ABSTRACT

A method performed by a user equipment (UE) is provided. The method includes receiving configuration information from a base station, the configuration information specifying a plurality of scheduling request (SR) configurations that indicate a plurality of SR occasions for communicating with the base station. The plurality of SR occasions are scheduled to occur when the base station is in a non-active duration of a current discontinuous transmission or reception (DTX/DRX) cycle. The method includes suspending transmission from the UE to the base station during at least one SR occasion of the plurality of SR occasions. The method includes determining that a triggering condition is met. The method includes transmitting a message to the base station in response to determining that the triggering condition is met. Also provided is a method performed by a base station.

### TECHNICAL FIELD

The present disclosure generally relates to wireless communication, and in particular, to transmitting scheduling request and buffer status report with cell discontinuous transmission or reception.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation (5G) New Radio (NR), among others. The wireless communication networks facilitate mobile broadband service using technologies such as orthogonal frequency-division multiplexing (OFDM), multiple input multiple output (MIMO), advanced channel coding, massive MIMO, beamforming, and/or other features.

Base station is a type of wireless access node in wireless communication networks that facilitate connection of user devices (e.g., user equipments, UEs) to the networks. Recent base stations have implemented a feature of discontinuous transmission or reception (DTX/DRX), which allows a base station to periodically enter a sleep mode and pause transmission and reception in order to save power. Each period of DTX/DRX is referred to as a DTX/DRX cycle. Each DTX/DRX cycle includes an active duration in which the base station actively performs transmission with one or more UEs, and a non-active duration in which the base station enters the sleep mode to save power.

### SUMMARY

In accordance with one aspect of the present disclosure, a method performed by a UE is provided. The method includes receiving configuration information from a base station, the configuration information specifying one or more scheduling request (SR) configurations that indicate a plurality of SR occasions for communicating with the base station. The plurality of SR occasions are scheduled to occur when the base station is in a non-active duration of a current DTX/DRX cycle. The method includes suspending transmission from the UE to the base station during at least one SR occasion of the plurality of SR occasions. The method includes determining that a triggering condition is met. The method includes transmitting a message to the base station in response to determining that the triggering condition is met.

In accordance with another aspect of the present disclosure, a method performed by a base station is provided. The method includes generating configuration information for a UE, with the configuration information specifying one or more SR configurations that indicate a plurality of SR occasions for the UE to communicate with the base station. The plurality of SR occasions are scheduled to occur when the base station is in a non-active duration of a first DTX/DRX cycle. The method includes entering the non-active duration of the first DTX/DRX cycle. The method includes entering an active duration of a second DTX/DRX cycle, the second DTX/DRX cycle occurring later than the first DTX/DRX cycle. The method includes receiving a message from the UE during the active duration of the second DTX/DRX cycle, wherein the message includes data stored in a UE buffer during the non-active duration of the first DTX/DRX cycle.

Various features of the disclosure can be implemented as program instructions stored on non-transitory computer-readable media and executable by one or more processors of a corresponding UE or base station.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIG. 2 illustrates an example timing diagram of a plurality of DTX/DRX cycles, according to some implementations.

FIG. 3A illustrates an example timing diagram with a UE determining suspended SR occasions and non-suspended SR occasions when a base station is in a non-active duration of a DTX/DRX cycle, according to some implementations.

FIG. 3B illustrates an example timing diagram with a UE determining timing for transmitting a message after a base station enters an active duration of a DTX/DRX cycle, according to some implementations.

FIG. 4 illustrates a flowchart of an example method, according to some implementations.

FIG. 5 illustrates a flowchart of an example method, according to some implementations.

FIG. 6 illustrates an example UE, according to some implementations.

FIG. 7 illustrates an example access node, according to some implementations.

### DETAILED DESCRIPTION

A base station, such as a g-Node B (gNB) or an e-Node B (eNB), can operate in DTX/DRX cycles while in communication with a UE in a RRC CONNECTED mode. These DTX/DRX cycles are referred to as Cell DTX/DRX cycles. The UE and the base station can exchange and process radio resource control (RRC) signaling and/or Layer One or Layer Two (L1/L2) signaling for the base station to activate or terminate DTX/DRX operations. Currently, when a base station operates in a non-active duration of a DTX/DRX cycle, the base station turns off communication with the UE except for signaling of random access channel (RACH), paging, or system information blocks (SIBs). While turning off such communication may lead to a gain of network energy saving (NES), it is possible that communication performance, such as Quality of Service (QOS), may be undermined. For example, turning off SR transmissions when the base station is in the non-active duration may cause the UE to overload the RACH. Furthermore, because the base station does not receive SRs and corresponding buffer status reports (BSRs) during the non-active duration of the DTX/DRX cycle, the base station may not know the status change of the UE's buffer.

This disclosure describes techniques to enhance communication between a base station and a UE while the base station is in Cell DTX/DRX cycles. As described below, in some implementations of the disclosed techniques, a UE is enabled to transmit SRs and corresponding BSRs to provide the base station with buffer status updates that take place while the base station is in a non-active duration of a DTX/DRX cycle. As such, the base station can remain informed of the UE's buffer status and take timely actions accordingly. As also described below, the disclosed implementations do not adversely affect NES gain.

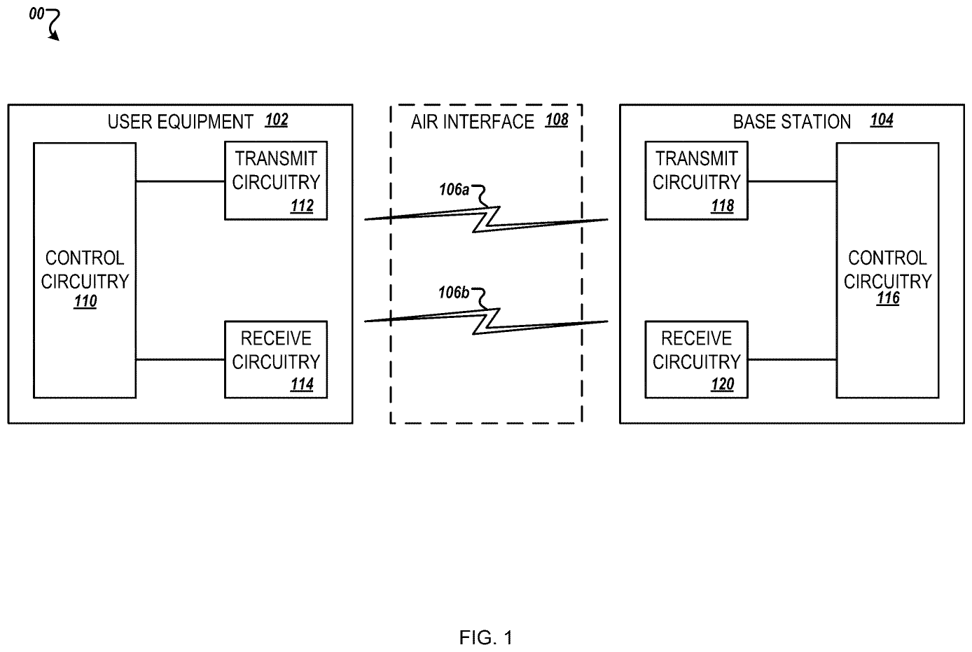

FIG. 1 illustrates an example wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates LTE and 5G NR communication standards as defined by the 3GPP technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. For instance, the control circuitry 110 can cause the UE 102 to enter or exit non-active durations and active durations in DTX/DRX cycles, and can control the transmit circuitry 112 and/or the receive circuitry 114 to schedule resources for the UE to transmit SR and/or BSR.

Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

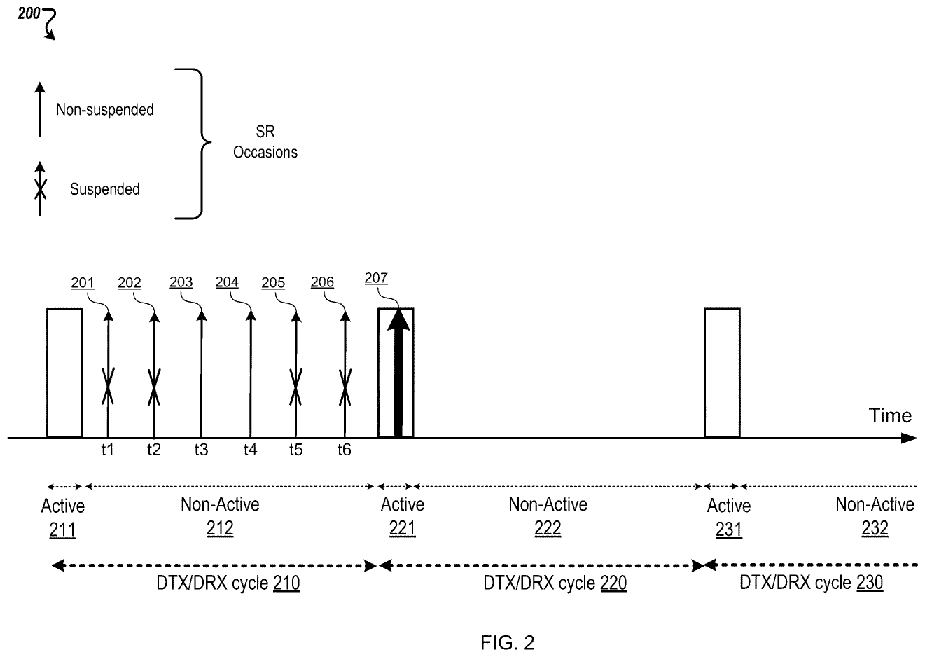

FIG. 2 illustrates an example timing diagram 200 of a plurality of DTX/DRX cycles, according to some implementations. Timing diagram 200 shows three consecutive DTX/DRX cycles 210, 220, and 230, which can be Cell DTX/DRX cycles in which a base station communicates with a UE. The below description of timing diagram 200 is based on an implementation in which the illustrated communication is between UE 102 and base station 104. As shown in timing diagram 200, DTX/DRX cycle 210 has active duration 211 and non-active duration 212. DTX/DRX cycle 220 has active duration 221 and non-active duration 222. DTX/DRX cycle 230 has active duration 231 and non-active duration 232.

Base station 104 can configure UE 102 (e.g., by sending UE 102 one or more SR configurations) with a plurality of SR occasions 201-206, which are scheduled to occur at times t1-t6, respectively, when base station 104 is in non-active duration 212. At each of SR occasions 201-206, UE 102 has an opportunity to transmit a SR to base station 104 even when base station 104 is non-active. By transmitting a SR, UE 102 can request base station 104 to allocate uplink resources for UE 102 subsequently to transmit a BSR corresponding to the SR.

While base station 104 is non-active, some or all of SR occasions 201-206 can be suspended. In the example timing diagram 200, SR occasions 201, 202, 205, and 206 are suspended, while SR occasions 203 and 204 are not suspended. In this case, UE 102 does not transmit SRs at suspended SR occasions 201, 202, 205, and 206, but can transmit SRs at non-suspended SR occasions 203 and 204. After base station 104 enters active duration 221 of DTX/DRX cycle 220, UE 102 can transmit SR and BSR at occasion 207, e.g., to account for the suspension at suspended SR occasions 201, 202, 205, and 206.

In some implementations, a UE suspends all of the SR occasions configured within a non-active duration. When a UE suspends all of the SR occasions within a non-active duration, the UE does not transmit SRs or BSRs during the non-active duration, even if the UE buffer receives data that normally would trigger a SR and/or BSR transmission. The UE can delay the SR and/or BSR transmission until the base station enters an active duration of a later DTX/DRX cycle. By not transmitting SRs or BSRs during the non-active duration, the UE does not consider the validity of a physical uplink control channel (PUCCH) and does not consider whether there is RACH transmission. The UE also stops one or more timers, such as SR-prohibit timer, BSR ReTX timer, and SR delay timer, if running.

Data arriving from various logic channels (LCHs) or LCH groups (LCGs) can accumulate (e.g., form a queue) at the UE's buffer due to the suspension of SRs and/or BSRs. Instead of utilizing the SR and the BSR to transmit the data in the buffer, the UE can transmit some of the data via RACH according to preconfigured conditions. For example, according to a preconfiguration from the base station, the UE can determine to transmit, via RACH, data received from certain LCHs or LCGs and not to transmit data received from other LCHs or LCGs.

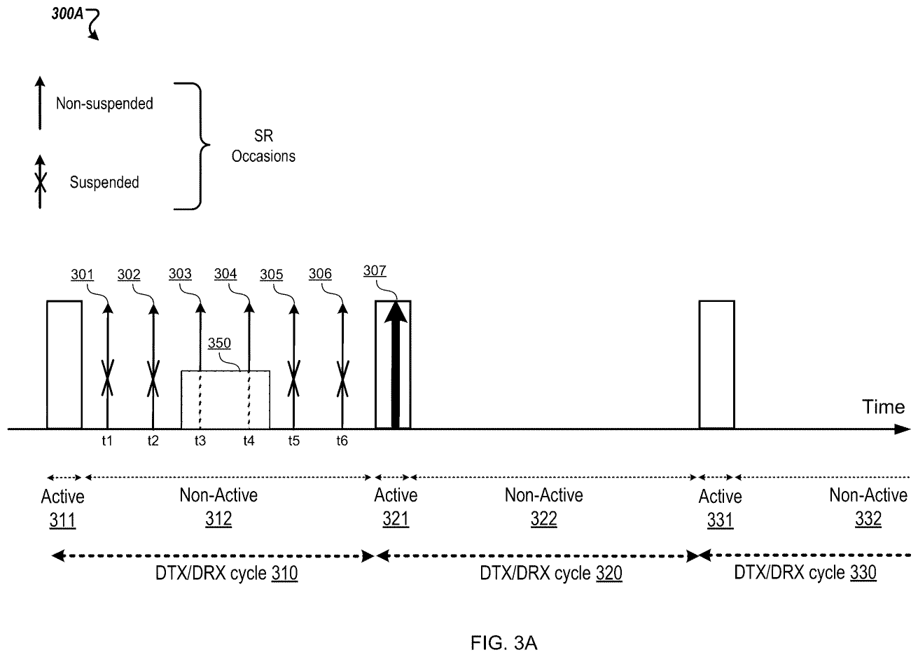

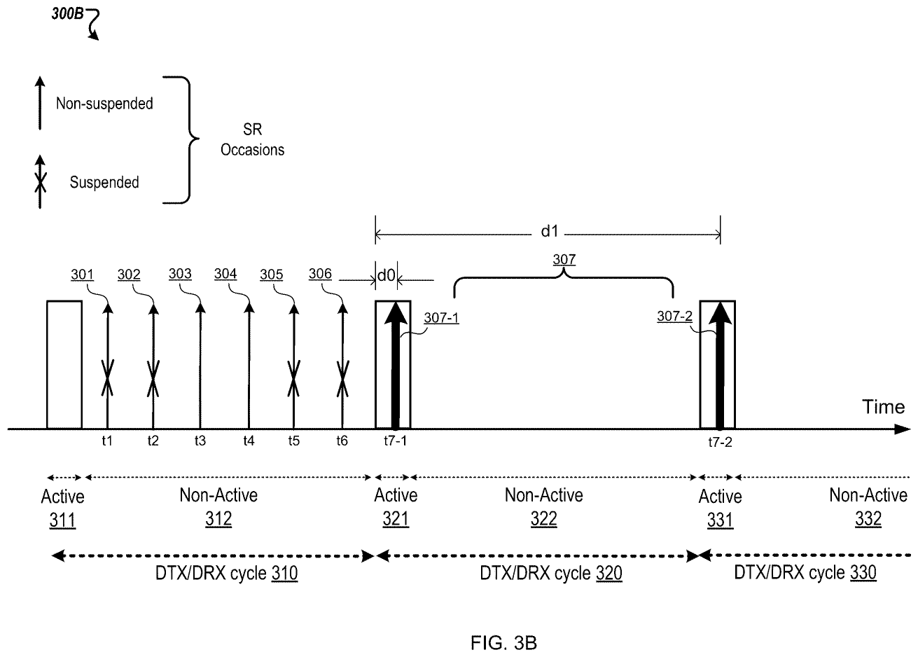

In some implementations, a UE, which is configured with a plurality of SR occasions scheduled to occur when the base station is non-active, can determine which SR occasions to suspend based on various factors. As an example, the UE can determine, at a given SR occasion, whether the buffer has received data from a LCH with a priority higher than a priority threshold. If the LCH or the specific piece of data is of high priority (e.g., sensitive to the queuing delay in the buffer), the UE can determine not to suspend the given SR occasion. Otherwise, the UE can determine to suspend the given SR occasion. Alternatively or additionally, the UE can determine the suspended and the non-suspended SR occasions based on information received from the base station, as exemplified in FIG. 3A.

FIG. 3A illustrates an example timing diagram 300A with a UE determining suspended SR occasions and non-suspended SR occasions when a base station is in a non-active duration of a DTX/DRX cycle, according to some implementations. Timing diagram 300A shows three consecutive DTX/DRX cycles 310, 320, and 330, which can be Cell DTX/DRX cycles for a base station communicating with a UE. The below description of timing diagram 300A is based on an implementation in which that the illustrated communication is between UE 102 and base station 104. As shown in timing diagram 300A, DTX/DRX cycle 310 has active duration 311 and non-active duration 312. DTX/DRX cycle 320 has active duration 321 and non-active duration 322. DTX/DRX cycle 330 has active duration 331 and non-active duration 332.

As shown, base station 104 configures UE 102 with a plurality of SR occasions 301-306, which are scheduled to occur at times t1-t6, respectively, when base station 104 is in non-active duration 312. In some implementations, base station 104 provides, via RRC signaling, UE 102 with a list, such as a list of SR configurations that include information of the SR occasions to be suspended or not to be suspended. For example, base station 104 can specify in the list that SR occasions at t3 and t4 are not to be suspended. Based on the list, UE 102 can determine not to suspend SR transmission at occasions 303 and 304 and to suspend SR transmission at occasions 301, 302, 305, and 306. In some implementations, base station 104 provides UE 102 with a time mask (e.g., a time window covering a specified time duration) 350. UE 102 can determine to suspend all SR occasions that occur outside of time mask 350. For example, UE 102 can determine to suspend occasions 301, 302, 305, and 306, which occur outside of time mask 350, and not to suspend occasions 303 and 304, which occur within time mask 350. In some implementations, depending on the configuration of the UE and/or instructions from the base station, UE 102 can determine to suspend all SR occasions that occur within the time mask specified by the base station 104.

SR transmissions at non-suspended occasions 303 and 304 do not significantly undermine the NES gain. First, transmissions at non-suspended occasions 303 and 304 typically occupy a very small amount of time in a non-active duration, so base station 104 only needs to activate its reception function very briefly. Furthermore, even without transmissions at non-suspended occasions 303 and 304, base station 104 would still need to activate its reception function for RACH signals, paging signals, and SIB signals. Compared to NES impact due to the reception of these signals, the NES impact from the non-suspended occasions 303 and 304 is less significant.

After SR transmissions at non-suspended occasions 303 and 304, UE 102 can determine whether retransmission is allowed based on, e.g., a retransmission configuration provided by base station 104. If retransmission is not allowed, UE 102 can start a timer, such as a CellDRXInactivity timer, after a SR transmission. Before the timer expires, UE 102 can wake up to monitor a physical downlink control channel (PDCCH) for signaling from base station 104 relating to physical downlink shared channel (PDSCH) receptions and/or physical uplink shared channel (PUSCH) transmissions. After the timer expires, UE 102 can stop monitoring the PDCCH. To avoid retransmission, UE 102 can keep HARQ-RTT-timer and a HARQ-ReTX-timer off (e.g., not starting HARQ-RTT-timer and HARQ-ReTX-timer). Conversely, if retransmission is allowed, UE 102 can follow similar procedures as if retransmission is not allowed, except that UE can start HARQ-RTT-timer after transmitting a PUSCH signal. After HARQ-RTT-timer expires, UE can start HARQ-ReTX-timer and subsequently monitor the PDCCH. Alternatively or additionally, UE 102 can determine at least one RACH-triggering condition based on configuration information from base station 104. For example, the configuration information can provide which of occasions 301, 302, 305, and 306 (or occasions 303 and 304) can trigger a RACH transmission.

The suspension at SR occasions 301, 302, 305, and 306 can cause base station 104 to temporarily lose track of certain changes happening at UE 102 while base station 104 is non-active. In such cases, after base station 104 enters the active duration of the next DTX/DRX cycle (e.g., active duration 321 of DTX/DRX cycle 320), UE 102 can transmit a message 307 to sync up with base station 104 about the changes. Message 307 can include one or more of the following items: i) a special SR having a high priority to indicate a buffer status change between a start of non-active duration 312 and an end of non-active duration 312; ii) a special BSR indicating the buffer status change; iii) a special BSR indicating a queuing delay (e.g., the time data has been queued in the buffer waiting for processing) change between the start of non-active duration 312 and the end of non-active duration 312; or iv) a RRC message (e.g., UE assistance information) indicating the buffer status change and/or the queuing delay change. For messages having item ii), an extended reality (XR) BSR can be used to indicate the queuing delay. The transmission of message 307 is exemplified in FIG. 3B.

FIG. 3B illustrates an example timing diagram 300B with a UE determining a timing for transmitting a message after a base station enters an active duration of a DTX/DRX cycle, according to some implementations. Timing diagram 300B, which can be similar to timing diagram 300A, shows three consecutive DTX/DRX cycles 310, 320, and 330. DTX/DRX cycle 310 has active duration 311 and non-active duration 312. DTX/DRX cycle 320 has active duration 321 and non-active duration 322. DTX/DRX cycle 330 has active duration 331 and non-active duration 332. The below description of timing diagram 300B is based on an implementation in which that the illustrated communication is between UE 102 and base station 104.

Base station 104 can configure UE 102 with a plurality of SR occasions 301-306 to occur during non-active duration 312, and UE 102 can determine to suspend SR occasions 301, 302, 305, and 306. After base station 104 enters active duration 321 of DTX/DRX cycle 320, UE 102 can determine to transmit a message 307, which can be either of messages 307-1 and 307-2, to, e.g., update base station 104 with the status changes happening to the buffer of UE 102.

In the implementation corresponding to timing diagram 300A, UE 102 can be set to transmit message 307 immediately upon determining base station 104's entry to active duration 321 in DTX/DRX cycle 320, the DTX/DRX cycle immediately following DTX/DRX cycles 310. However, in scenarios where base station 104 is in the RRC CONNECTED mode with multiple UEs, such setting may lead to multiple UEs transmitting messages at approximately the same time, potentially causing collisions when base station 104 attempts to receive all of the messages.

To reduce the risk of collision, a base station can provide each UE with a UE-specific time offset, which can be measured as absolute time (e.g., milliseconds), as a number of DTX/DRX cycles, or as a number of active or non-active durations. The time offset can be fixed or can be randomly determined by the base station. Each UE then holds the transmission of the message for a period equal to or greater than the time offset. For example, as shown by timing diagram 300B, base station 104 can provide UE 102 with a time offset equal to do, where do can be in the unit of milliseconds. Thus, after base station 104 enters active duration 321, UE 102 can wait a period of d0 before transmitting message 307 (which is shown as message 307-1 for this case) at time t7-1. Alternatively, base station 104 can provide UE 102 with a time offset equal to d1, where d1 can be represented as one DTX/DRX cycle. Thus, after base station 104 enters active duration 321, UE 102 can wait a period equal to the length of one DTX/DRX cycle (e.g., skip DTX/DRX cycle 320) until DTX/DRX cycle 330 before transmitting message 307 (which is shown as message 307-2 for this case) at time t7-2.

In some implementations, base station 104's entry to the next active duration does not necessarily cause UE 102 to transmit message 307 (either immediately or after the time offset). In these implementations, UE 102 can further determine whether one or more conditions are met. If these conditions are not met, UE 102 can determine that transmission of message 307 during this active duration is not needed despite the suspension of SR occasions in the previous non-active duration. These conditions can include one or more of: a) the amount of all buffered data exceeds a volume threshold; b) the amount of buffered data received from certain LCHs or LCGs exceeds a volume threshold; c) any of the buffered data has remained in the buffer for a queuing delay longer than a delay threshold; or d) any of the buffered data received from certain LCHs or LCGs has remained in the buffer for a queuing delay longer than a delay threshold. Performing transmission of message 307 based on satisfying one or more of these conditions can help avoid unnecessary transmissions and reduce power consumption.

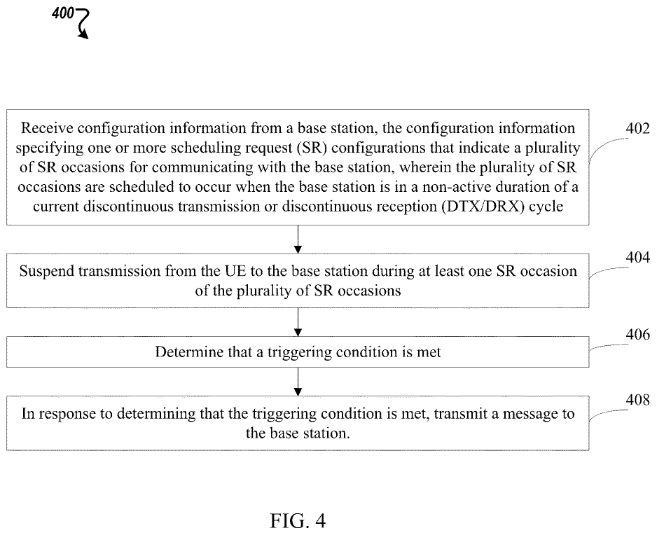

FIG. 4 illustrates a flowchart of an example method 400, according to some implementations. For clarity of presentation, the description that follows generally describes method 400 in the context of the other figures in this description. For example, method 400 can be performed by UE 102 of FIG. 1. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

At 402, method 400 involves receiving configuration information from a base station, such as base station 104 of FIG. 1. The configuration information specifies one or more SR configurations that indicate a plurality of SR occasions for communicating with the base station. The plurality of SR occasions are scheduled to occur when the base station is in a non-active duration of a current DTX/DRX cycle, such as non-active duration 212 of DTX/DRX cycle 210 of FIG. 2 or non-active duration 312 of DTX/DRX cycle 310 of FIGS. 3A and 3B.

At 404, method 400 involves suspending transmission from the UE to the base station during at least one SR occasion of the plurality of SR occasions. The at least one SR occasion can be, e.g., SR occasions 201, 202, 205, and 206 of FIG. 2 or SR occasions 301, 302, 305, and 306 of FIGS. 3A and 3B.

At 406, method 400 involves determining that a triggering condition is met. The triggering condition can include that the base station enters an active duration of a next DTX/DRX cycle, and can further include one or more of conditions a) to d) described above.

At 408, method 400 involves transmitting a message to the base station in response to determining that the triggering condition is met. The message can be similar to message 207 of FIG. 2 or message 307 of FIGS. 3A and 3B.

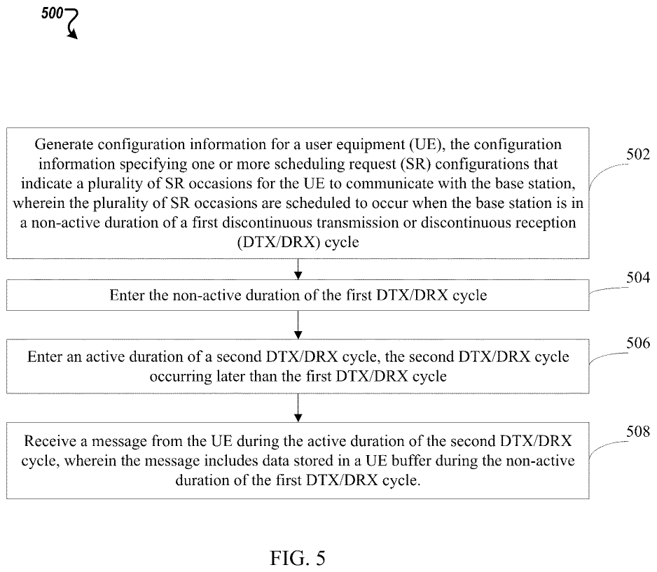

FIG. 5 illustrates a flowchart of an example method 500, according to some implementations. For clarity of presentation, the description that follows generally describes method 500 in the context of the other figures in this description. For example, method 500 can be performed by base station 104 of FIG. 1. It will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order.

At 502, method 500 involves generating configuration information for a UE. The configuration information can specify one or more configurations that indicate a plurality of SR occasions for the UE to communicate with the base station. The plurality of SR occasions are scheduled to occur when the base station is in a non-active duration of a first DTX/DRX cycle, such as non-active duration 212 of DTX/DRX cycle 210 of FIG. 2 or non-active duration 312 of DTX/DRX cycle 310 of FIGS. 3A and 3B.

At 504, method 500 involves entering the non-active duration of the first DTX/DRX cycle.

At 506, method 500 involves entering an active duration of a second DTX/DRX cycle, such as active duration 221 of DTX/DRX cycle 220 of FIG. 2 or active duration 321 of DTX/DRX cycle 320 of FIGS. 3A and 3B. The second DTX/DRX cycle occurs later than the first DTX/DRX cycle.

At 508, method 500 involves receiving a message from the UE during the active duration of the second DTX/DRX cycle. The message includes data stored in a UE buffer during the non-active duration of the first DTX/DRX cycle.

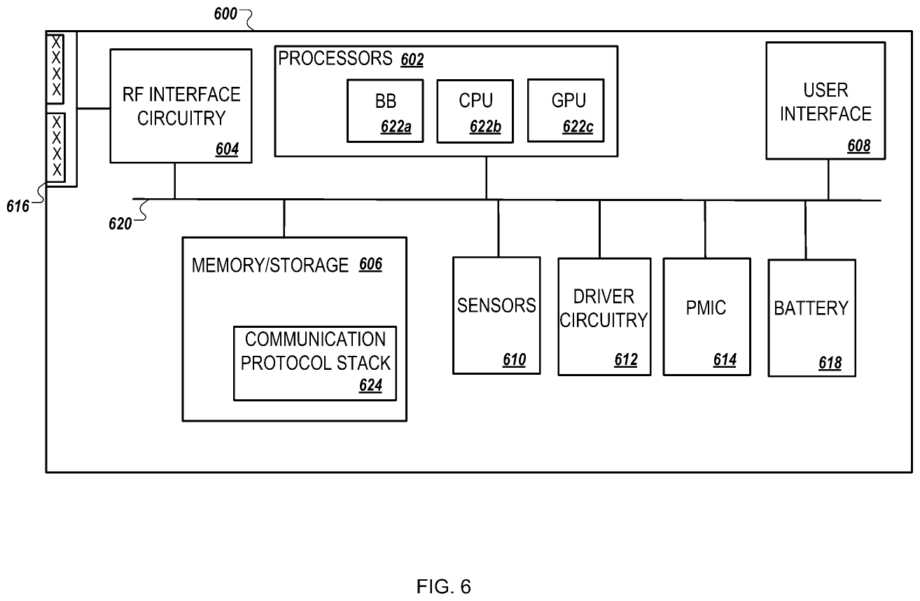

FIG. 6 illustrates an example UE 600, according to some implementations. The UE 600 may be similar to and substantially interchangeable with UE 102 of FIG. 1.

The UE 600 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 600 may include processors 602, RF interface circuitry 604, memory/storage 606, user interface 608, sensors 610, driver circuitry 612, power management integrated circuit (PMIC) 614, antenna structure 616, and battery 618. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc. that allows various circuit components (on common or different chips or chipsets) to interact with one another.

The processors 602 may include processor circuitry such as, for example, baseband processor circuitry (BB) 622A, central processor unit circuitry (CPU) 622B, and graphics processor unit circuitry (GPU) 622C. The processors 602 may include any type of circuitry or processor circuitry that executes or otherwise operates computer-executable instructions, such as program code, software modules, or functional processes from memory/storage 606 to cause the UE 600 to perform operations as described herein.

In some implementations, the baseband processor circuitry 622A may access a communication protocol stack 624 in the memory/storage 606 to communicate over a 3GPP compatible network. In general, the baseband processor circuitry 622A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 604. The baseband processor circuitry 622A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 606 may include one or more non-transitory, computer-readable media that includes instructions (for example, communication protocol stack 624) that may be executed by one or more of the processors 602 to cause the UE 600 to perform various operations described herein. The memory/storage 606 include any type of volatile or non-volatile memory that may be distributed throughout the UE 600. In some implementations, some of the memory/storage 606 may be located on the processors 602 themselves (for example, L1 and L2 cache), while other memory/storage 606 is external to the processors 602 but accessible thereto via a memory interface. The memory/storage 606 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 604 may include transceiver circuitry and radio frequency front module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 616 and proceed to filter and amplify (with a low-noise amplifier) the signal. The signal may be provided to a receiver of the transceiver that downconverts the RF signal into a baseband signal that is provided to the baseband processor of the processors 602.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 616. In various implementations, the RF interface circuitry 604 may be configured to transmit/receive signals in a manner compatible with NR access technologies.

The antenna 616 may include antenna elements to convert electrical signals into radio waves to travel through the air and to convert received radio waves into electrical signals. The antenna elements may be arranged into one or more antenna panels. The antenna 616 may have antenna panels that are omnidirectional, directional, or a combination thereof to enable beamforming and multiple input, multiple output communications. The antenna 616 may include microstrip antennas, printed antennas fabricated on the surface of one or more printed circuit boards, patch antennas, phased array antennas, etc. The antenna 616 may have one or more panels designed for specific frequency bands including bands in FR1 or FR2.

The user interface 608 includes various input/output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various input/output (I/O) devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensor circuitry 628 and control and allow access to sensor circuitry 628, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processors 602, the PMIC 614 may control power-source selection, voltage scaling, battery charging, or DC-to-DC conversion.

In some implementations, the PMIC 614 may control, or otherwise be part of, various power saving mechanisms of the UE 600. A battery 618 may power the UE 600, although in some examples the UE 600 may be mounted deployed in a fixed location, and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

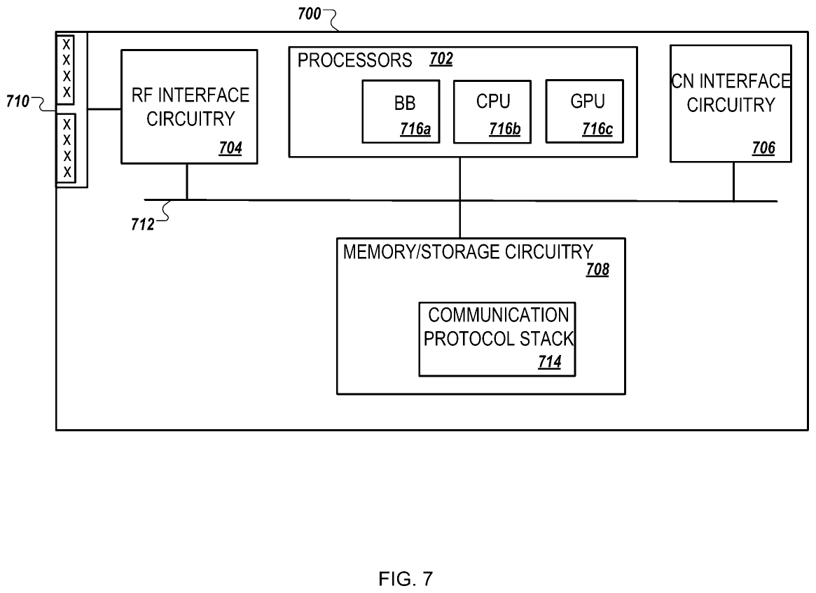

FIG. 7 illustrates an example access node 700 (e.g., a base station or gNB), according to some implementations. The access node 700 may be similar to and substantially interchangeable with base station 104. The access node 700 may include processors 702, RF interface circuitry 704, core network (CN) interface circuitry 706, memory/storage circuitry 708, and antenna structure 710.

The components of the access node 700 may be coupled with various other components over one or more interconnects 712. The processors 702, RF interface circuitry 704, memory/storage circuitry 708 (including communication protocol stack 714), antenna structure 710, and interconnects 712 may be similar to like-named elements shown and described with respect to FIG. 6. For example, the processors 702 may include processor circuitry such as, for example, baseband processor circuitry (BB) 716A, CPU 716B, and GPU 716C.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual baseband unit pool (vBBUP). In V2X scenarios, the access node 700 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary implementations are provided.

Example 1 includes a method performed by a UE. The method includes receiving configuration information from a base station, the configuration information specifying a plurality of SR configurations that indicate a plurality of SR occasions for communicating with the base station. The plurality of SR occasions are scheduled to occur when the base station is in a non-active duration of a current DTX/DRX cycle. The method includes suspending transmission from the UE to the base station during at least one SR occasion of the plurality of SR occasions. The method includes determining that a triggering condition is met. The method includes transmitting a message to the base station in response to determining that the triggering condition is met.

Example 2 may include the method of example 1, wherein determining the at least one SR occasion comprises: receiving a list of SR configurations from the base station and via radio resource control (RRC) signaling, and wherein the at least one SR occasion is determined based on the list.

Example 3 may include the method of example 1 or 2, wherein suspending transmission from the UE to the base station during the at least one SR occasion includes determining, at the at least one SR occasion, whether a UE buffer has received data having a priority equal to or lower than a priority threshold.

Example 4 may include the method of any of examples 1 to 3, wherein suspending transmission from the UE to the base station during the at least one SR occasion includes: determining a time mask according to the configuration information from the base station; and determining an SR occasion of the plurality of SR occasions outside the time mask as the at least one SR occasion for suspending transmission.

Example 5 may include the method of any of examples 1 to 4, further including: suspending transmission from the UE to the base station during each of the plurality of SR occasions.

Example 6 may include the method of example 5, further including stopping at least one of: a SR-prohibit timer, a BSR retransmission timer, or a SR delay timer.

Example 7 may include the method of any of examples 1 to 4, further including: determining, from the plurality of SR occasions, at least one non-suspended SR occasion, wherein the at least one non-suspended SR occasion is different from the at least one SR occasion; transmitting an SR to the base station at the at least one non-suspended SR occasion; and transmitting a BSR corresponding to the SR.

Example 8 may include the method of example 7, further including: determining, based on a retransmission configuration, that retransmission is not allowed; starting a first timer after transmitting the SR to the base station; monitoring a PDCCH after the first timer starts and before the first timer expires; and keeping a HARQ-RTT-timer and a HARQ-ReTX-timer off.

Example 9 may include the method of example 7, further including: determining, based on a retransmission configuration, that retransmission is allowed; starting a first timer after transmitting the SR to the base station; starting a HARQ-RTT-timer after transmitting a PUSCH signal; starting a HARQ-ReTX-timer after the HARQ-RTT-timer expires; and monitoring a PDCCH after the HARQ-ReTX-timer starts and before the first timer expires.

Example 10 may include the method of any of examples 7 to 9, further including: determining at least one RACH-triggering condition from the at least one SR occasion.

Example 11 may include the method of any of examples 1 to 10, wherein the triggering condition includes: the base station enters an active duration of a later DTX/DRX cycle, the later DTX/DRX cycle occurring later than the current DTX/DRX cycle.

Example 12 may include the method of example 11, wherein the triggering condition further includes: a buffer storing data received prior to the base station entering the active duration of the later DTX/DRX cycle; and an amount of the data being greater than a volume threshold.

Example 13 may include the method of example 11, wherein the triggering condition further includes: a buffer storing data received from one or more particular logical channels or from one or more particular logical channel groups prior to the base station entering the active duration of the later DTX/DRX cycle; and an amount of the data being greater than a volume threshold.

Example 14 may include the method of example 11, wherein the triggering condition further includes: a buffer storing data received prior to the base station entering the active duration of the later DTX/DRX cycle; and the data being present in the buffer for a queuing delay longer than a delay threshold.

Example 15 may include the method of example 14, wherein the triggering condition further includes: the data was received from one or more particular logical channels or from one or more particular logical channel groups.

Example 16 may include the method of any of examples 1 to 15, further including: receiving a time offset from the base station; and in response to determining that the triggering condition is met, waiting a period equal to or greater than the time offset before transmitting the message to the base station.

Example 17 may include the method of example 16, wherein the time offset is in a unit of at least one of: number of DTX/DRX cycles, number of non-active durations, or number of active durations.

Example 18 may include the method of example 16 or 17, wherein the time offset is randomly determined.

Example 19 may include the method of any of examples 1 to 18, wherein the message includes at least one of: a special SR indicating a buffer status change between a start of the non-active duration and an end of the non-active duration, a first special BSR indicating the buffer status change, a second special BSR indicating a queuing delay change between the start of the non-active duration and the end of the non-active duration, a RRC message indicating at least one of: the buffer status change, or the queuing delay change.

Example 20 includes a UE including one or more processors configured to execute instructions that cause the UE to perform the method of any of examples 1-19 Example 21 includes a UE including radio frequency (RF) processing circuitry configured to receive configuration information from a base station; and baseband processing circuitry to execute instructions that cause the UE to perform the method of any of examples 1-19.

Example 22 includes one or more processors for a UE. The one or more processors are configured to execute instructions stored in memory coupled to the one or more processors to perform the method of any of examples 1-19.

Example 23 includes a non-transitory computer-readable medium storing program instructions that, when executed, cause a UE to perform the method of any of examples 1-19.

Example 24 includes a method performed by a base station. The method includes generating configuration information for a UE, with the configuration information specifying a plurality of SR configurations that indicate a plurality of SR occasions for the UE to communicate with the base station. The plurality of SR occasions are scheduled to occur when the base station is in a non-active duration of a first DTX/DRX cycle. The method includes entering the non-active duration of the first DTX/DRX cycle. The method includes entering an active duration of a second DTX/DRX cycle, the second DTX/DRX cycle occurring later than the first DTX/DRX cycle. The method includes receiving a message from the UE during the active duration of the second DTX/DRX cycle, wherein the message includes data stored in a UE buffer during the non-active duration of the first DTX/DRX cycle.

Example 25 may include the method of example 24, further including: transmitting a list to the UE via RRC signaling.

Example 26 may include the method of example 24, further including: configuring the UE with a time mask, wherein the at least one SR occasion occurs outside the time mask.

Example 27 may include the method of any of examples 24-26, further including: causing the UE to suspend transmission at all of the plurality of SR occasions.

Example 28 may include the method of any of examples 24-26, further including: causing the UE to suspend transmission at at least one SR occasion of the plurality of SR occasions; receiving an SR from the UE at at least one non-suspended SR occasion of the plurality of SR occasions, the at least one non-suspended SR occasion being different from the at least one SR occasion; and receiving a BSR corresponding to the SR from the UE.

Example 29 may include the method of any of examples 24-28, further including: transmitting a time offset to the UE, wherein the message is received from the UE at least the time offset after the base station enters the non-active duration of the first DTX/DRX cycle.

Example 30 may include the method of example 29, wherein the time offset is in a unit of at least one of: number of DTX/DRX cycles, number of non-active durations, or number of active durations.

Example 31 may include the method of example 29 or 30, wherein the time offset is randomly determined.

Example 32 may include the method of any of examples 24 to 31, wherein the message includes at least one of: a special SR indicating a buffer status change between a start of the non-active duration of the first DTX/DRX cycle and an end of the non-active duration of the first DTX/DRX cycle, a first special BSR indicating the buffer status change, a second special BSR indicating a queuing delay change between the start of the non-active duration of the first DTX/DRX cycle and the end of the non-active duration of the first DTX/DRX cycle, a RRC message indicating at least one of: the buffer status change, or the queuing delay change.

Example 33 includes a base station including one or more processors configured to execute instructions that cause the base station to perform the method of any of examples 24 to 32.

Example 34 includes a non-transitory computer-readable medium storing program instructions that, when executed, cause a base station to perform the method of any of examples 24 to 32.

Example 35 may include one or more non-transitory computer-readable media including instructions to cause an electronic device, upon execution of the instructions by one or more processors of the electronic device, to perform one or more elements of a method described in or related to any of the above-described examples, or any other method or process described herein.

Example 36 may include an apparatus including logic, modules, or circuitry to perform one or more elements of a method described in or related to any of the above-described examples, or any other method or process described herein.

Example 37 may include a method, technique, or process as described in or related to any of the above-described examples, or portions or parts thereof.

Example 38 may include an apparatus including: one or more processors and one or more computer-readable media including instructions that, when executed by the one or more processors, cause the one or more processors to perform the method, techniques, or process as described in or related to any of the above-described examples, or portions thereof.

Example 39 may include a signal as described in or related to any of the above-described examples, or portions or parts thereof.

Example 40 may include a datagram, information element, packet, frame, segment, PDU, or message as described in or related to any of the above-described examples, or portions or parts thereof, or otherwise described in the present disclosure.

Example 41 may include a signal encoded with data as described in or related to any of the above-described examples, or portions or parts thereof, or otherwise described in the present disclosure.

Example 42 may include a signal encoded with a datagram, IE, packet, frame, segment, PDU, or message as described in or related to any of the above-described examples, or portions or parts thereof, or otherwise described in the present disclosure.

Example 43 may include an electromagnetic signal carrying computer-readable instructions, wherein execution of the computer-readable instructions by one or more processors is to cause the one or more processors to perform the method, techniques, or process as described in or related to any of the above-described examples, or portions thereof.

Example 44 may include a computer program including instructions, wherein execution of the program by a processing element is to cause the processing element to carry out the method, techniques, or process as described in or related to any of the above-described examples, or portions thereof. The operations or actions performed by the instructions executed by the processing element can include the methods of any of the above-described examples.

Example 45 may include a signal in a wireless network as shown and described herein.

Example 46 may include a method of communicating in a wireless network as shown and described herein.

Example 47 may include a system for providing wireless communication as shown and described herein. The operations or actions performed by the system can include the methods of any of the above-described examples.

Example 48 may include a device for providing wireless communication as shown and described herein. The operations or actions performed by the device can include the methods of any of the above-described examples.

The previously-described examples are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of the above-described examples.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-34. (canceled)

35. A method comprising:
receiving radio resource control (RRC) signaling that configures a discontinuous reception (DRX) cycle corresponding to a serving cell;
determining that (i) DRX is activated and (ii) the serving cell is in a non-active period of the DRX cycle;
suspending transmission of at least one SR during the non-active period of the DRX cycle; and
refraining from starting a timer associated with the suspended transmission of the at least one SR.

36. The method of claim 35, wherein the RRC signaling activates DRX for the serving cell.

37. The method of claim 35, wherein suspending transmission of the at least one SR comprises suspending transmission of the at least one SR until the serving cell enters an active duration of the DRX cycle.

38. The method of claim 35, wherein the timer comprises an SR prohibit timer.

39. The method of claim 35, further comprising receiving second RRC signaling that configures a plurality of SR occasions for the serving cell, wherein at least one of the plurality of SR occasions is within the non-active period of the DRX cycle.

40. The method of claim 35, further comprising:
determining that a trigger condition is met; and
transmitting an uplink message on the serving cell based at least in part on determining that the trigger condition is met.

41. The method of claim 40, wherein determining that the trigger condition is met comprises determining that the serving cell is in an active period of the DRX cycle.

42. The method of claim 35, wherein DRX and discontinuous transmission (DTX) are both configured for the serving cell.

43. An apparatus comprising:
one or more processors; and
memory storing instructions that, when executed, are configured to cause the one or more processors to perform operations comprising:
receiving radio resource control (RRC) signaling that configures a discontinuous reception (DRX) cycle corresponding to a serving cell;
determining that (i) DRX is activated and (ii) the serving cell is in a non-active period of the DRX cycle;
suspending transmission of at least one SR during the non-active period of the DRX cycle; and
refraining from starting a timer associated with the suspended transmission of the at least one SR.

44. The apparatus of claim 43, wherein the RRC signaling activates DRX for the serving cell.

45. The apparatus of claim 43, wherein suspending transmission of the at least one SR comprises suspending transmission of the at least one SR until the serving cell enters an active duration of the DRX cycle.

46. The apparatus of claim 43, wherein the timer comprises an SR prohibit timer.

47. The apparatus of claim 43, wherein the operations further comprise receiving second RRC signaling that configures a plurality of SR occasions for the serving cell, wherein at least one of the plurality of SR occasions is within the non-active period of the DRX cycle.

48. The apparatus of claim 43, wherein the operations further comprise:
determining that a trigger condition is met; and
transmitting an uplink message on the serving cell based at least in part on determining that the trigger condition is met.

49. The apparatus of claim 48, wherein determining that the trigger condition is met comprises determining that the serving cell is in an active period of the DRX cycle.

50. The apparatus of claim 43, wherein DRX and discontinuous transmission (DTX) are both configured for the serving cell.

51. One or more non-transitory machine-readable media storing instructions that, when executed, are configured to cause one or more processors to perform operations comprising:
receiving radio resource control (RRC) signaling that configures a discontinuous reception (DRX) cycle corresponding to a serving cell;
determining that (i) DRX is activated and (ii) the serving cell is in a non-active period of the DRX cycle;
suspending transmission of at least one SR during the non-active period of the DRX cycle; and
refraining from starting a timer associated with the suspended transmission of the at least one SR.

52. The one or more non-transitory machine-readable media of claim 51, wherein the RRC signaling activates DRX for the serving cell, and
wherein suspending transmission of the at least one SR comprises suspending transmission of the at least one SR until the serving cell enters an active duration of the DRX cycle.

53. The one or more non-transitory machine-readable media of claim 51, wherein the operations further comprise receiving second RRC signaling that configures a plurality of SR occasions for the serving cell, wherein at least one of the plurality of SR occasions is within the non-active period of the DRX cycle.

54. The one or more non-transitory machine-readable media of claim 51, wherein the operations further comprise:
determining that a trigger condition is met upon determining that the serving cell is in an active period of the DRX cycle; and
transmitting an uplink message on the serving cell based at least in part on determining that the trigger condition is met.
